(19) United States
(12) Patent Application Publication
(10) Pub. No.: US 2013/0335995 A1
(43) Pub. Date: Dec. 19, 2013

(54) LIGHT RESOURCE MODULE WITH LARGER ILLUMINATION AREA AND A LIGHTING FIXTURE THEREOF

(71) Applicant: TSANN KUEN (ZHANG ZHOU) ENTERPRISE CO., LTD., Zhang Zhou (CN)

(72) Inventors: KU Te-Kai, Zhubei City (TW); Nai-Chiang PAI, Taipei City (TW)

(21) Appl. No.: 13/918,248

(22) Filed: Jun. 14, 2013

(30) Foreign Application Priority Data
Jun. 15, 2012 (CN) 201220284795.X

(51) Int. Cl. F21V 8/00; F21V 29/00

(52) U.S. Cl. CPC G02B 6/0096; F21V 29/2206
USPC 362/555

(57) ABSTRACT

The present invention is provided with a light resource module with larger illumination area, wherein comprising a curve light guide column, the surface of which is formed with several microstructures with light scattering, light refraction or light reflex functions; and two LED light resources, which are corresponding to the two ends of the light guide column The present invention is further provided with a lighting fixture, which comprising at least a light guide column, a heat emission element and a heat conduction element. The present invention of a light resource module with larger illumination area and a lighting fixture thereof have advantages that light is guided to the rear area of the light resource module to enlarge illumination area and reduce unavailable area, making the light resource module and the lighting fixture with larger illumination area.

### FIELD OF THE INVENTION

The present invention relates to a light resource module with larger illumination area and a lighting fixture thereof, especially to a light resource module with larger illumination area and a lighting fixture that can guide light to the rear area.

### BACKGROUND OF THE INVENTION

There are several types of light resource modules according to different light emission principle. The light resource module applied with LED as its light resource has well light conversion efficiency, fixed wavelength and adjustable luminous and quality, making it wide used in the world. Besides, LED is small-sized, low heat emission and long service life.

However, though with above advantages, this kind of the light resource module has its natural defect. No matter what light emission principle the light resource is, the light resource module is limited by its illumination area. Usually, the illumination area of the LED light resource is about 120 degrees, so the direct light is the highest and light in the side and rear area are weaker even unavailable, forming the unavailable area (or dark area). To enhance the illumination of the unavailable area, it needs to add more lighting fixtures, which is energy wasting and energy consumption.

### SUMMARY OF THE INVENTION

The present invention is provided with a light resource module with larger illumination area and a lighting fixture thereof, which can guide light to the rear area, reduce the unavailable area and enlarge the illumination area. The technical proposal of the present invention to solve the technical problems is as below:

A light resource module with larger illumination area comprising:

A curve light guide column, the surface of which is formed with several microstructures with light scattering, light refraction or light reflex functions; and

Two LED light resources, which are corresponding to the two ends of the light guide column

Two ends of the light guide column are separately disposed with a space, two LED light sources are separately accommodated inside the two spaces.

The microstructures on the surface of the light guide column are pyramid shaped, conical shaped or spherical shaped.

The microstructures on the surface of the light guide column are spread on the surface of the light guide column

The two LED light sources are connected to a heat conduction element.

A lighting fixture comprising:

At least a curve light guide column, the surface of the light guide column is disposed with several microstructures with light scattering, light refraction or light reflex functions;

At least two LED light resources, which are corresponding to the two ends of the light guide column;

A heat emission element, which is disposed with several heat emission fins, one end of the heat emission element is disposed with a power socket, the other end is disposed with a contact surface; and

A heat conduction element, which is connected to the contact surface, the light guide column is assembled in the heat conduction element.

Two ends of the light guide column are separately disposed with a space, the LED light sources are separately accommodated in the spaces.

The light emission fins are spaced arranged.

The light conduction element is a circuit board.

Compared to the existing technology, the present invention has advantageous effects as below:

1. Light is influenced by the microstructures when passing through the light, coursing light scattering, light refraction and light reflex, so that light is guided to the rear area of the light resource module to enlarge illumination area and reduce unavailable area, making the light resource module and the lighting fixture with larger illumination area.

2. No other lighting fixture is added to the light resource module and the lighting fixture to enhance the illumination effect, making it with power-saving advantage.

3. The light guide column is expertly designed; several light guide columns can be assembled on the light conduction element to increase the lightness.

### BRIEF DESCRIPTION OF THE DRAWINGS

The present invention will be further described with the drawings and embodiments.

FIG. 1 illustrates the structure of a light resource module with larger illumination area of the present invention.

FIG. 2 illustrates the breakdown structure of a light resource module with larger illumination area of the present invention.

FIG. 3 illustrates the structure of a light resource module with larger illumination area of the present invention in working state.

FIG. 4 illustrates the partial enlargement view of the light illumination path inside the light guide column of FIG. 3.

FIG. 5A, FIG. 5B, FIG. 5C separately illustrates the partial enlargement view of the microstructures of the light guide column of FIG. 4.

### REFERENCE SIGNS

1. Light guide column, 2. Heat emission element. 11. Microstructure, 21. Heat emission fin, 12. Space, 22. Power socket. 13. LED light source, 23. Contact surface, 3. Heat conduction element.

### DETAILED DESCRIPTION OF THE EMBODIMENTS

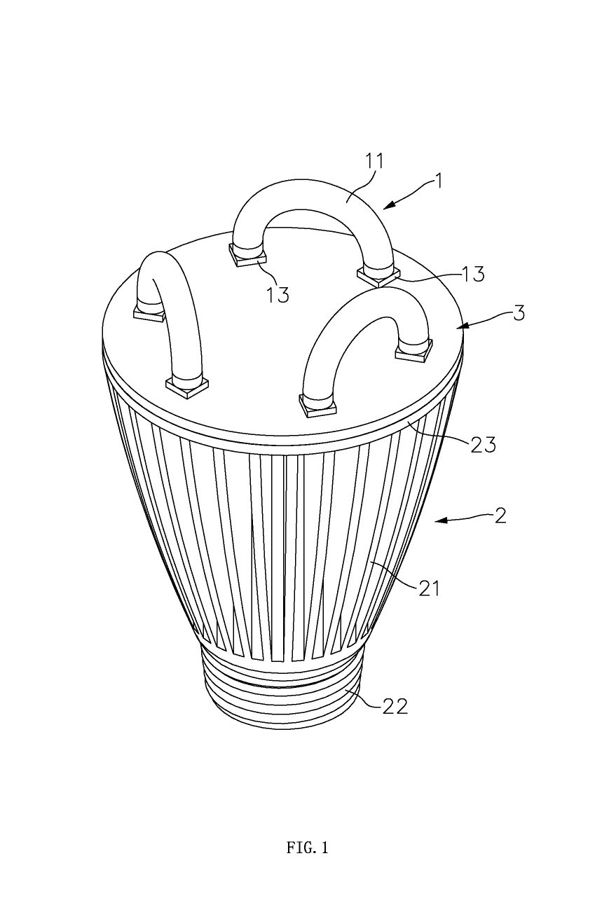

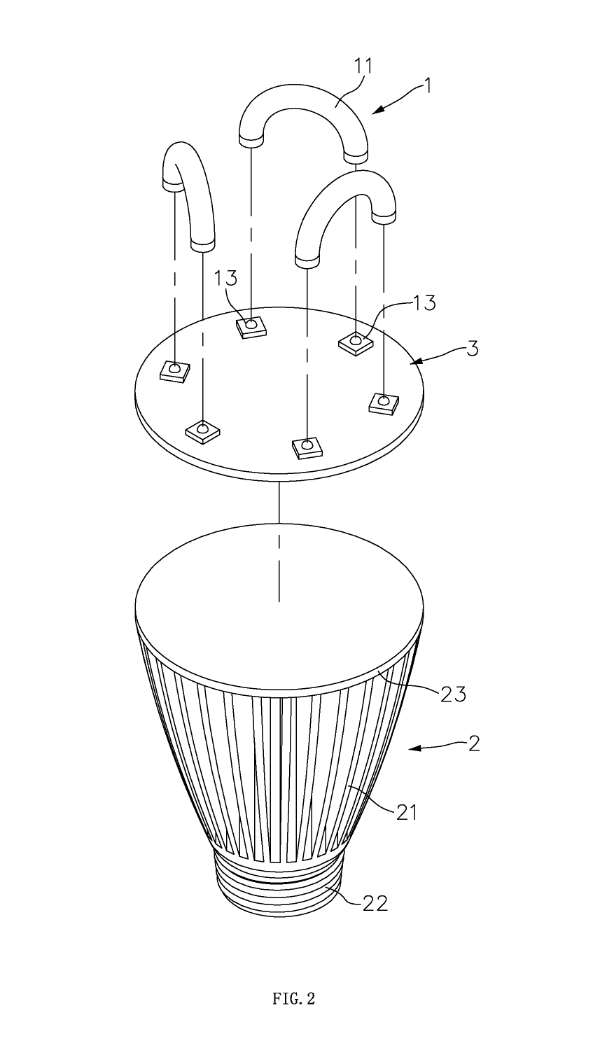

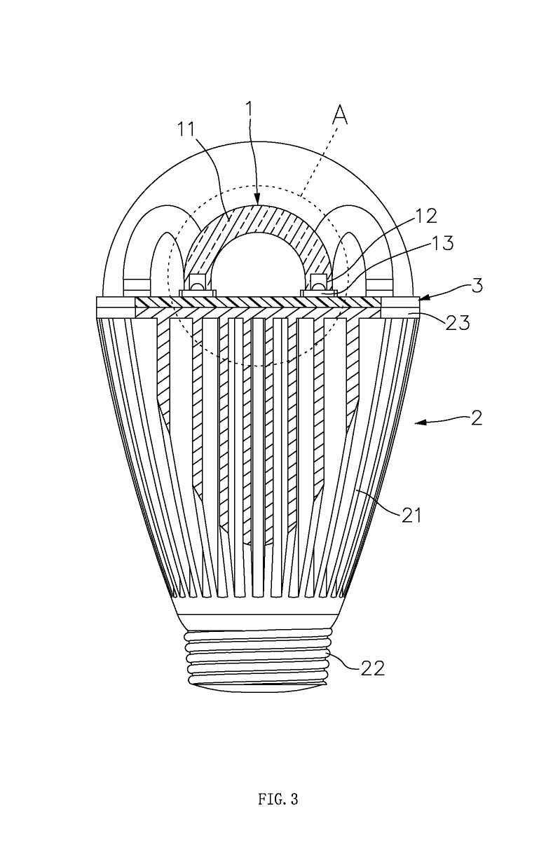

Refer to FIG. 1 to FIG. 3. A light resource module with larger illumination area of the present invention comprising a curve light guide column 1, several microstructures 11 forming on the surface of the light guide column 1, two spaces 12 in two ends of the light guide column 1 and two LED light resources 13 corresponding to the two ends of the light guide column 1.

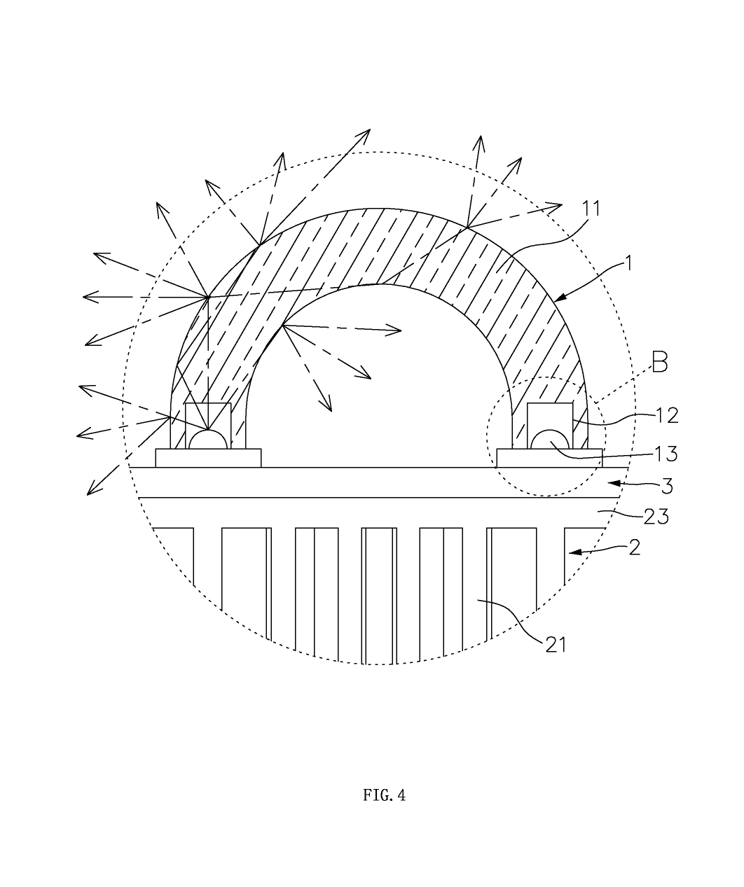

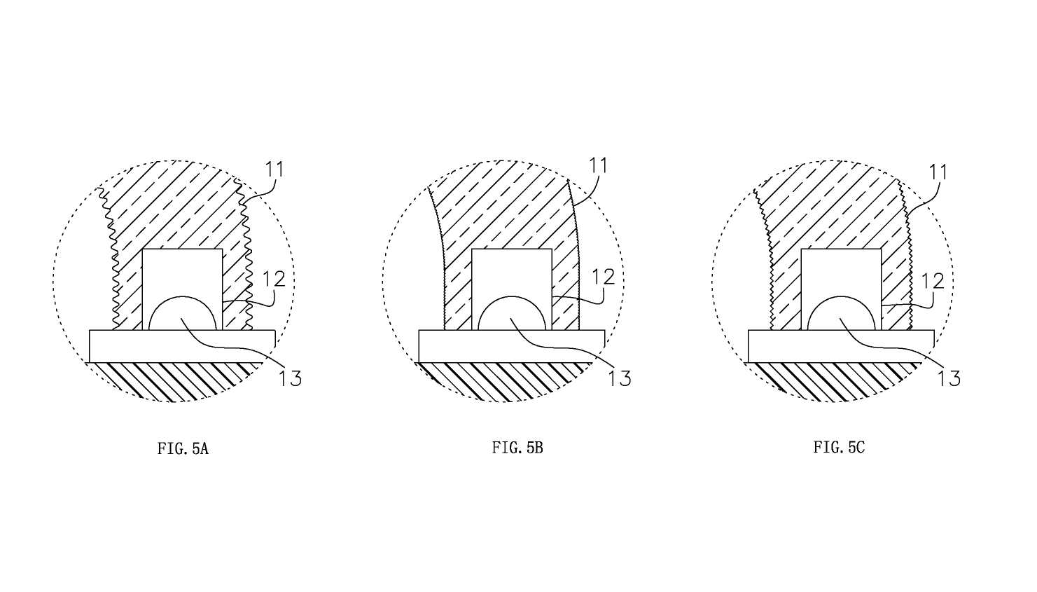

The microstructures 11 are some specified designed structure by calculation and experiments, they can be pyramid shaped, conical shaped or spherical shaped (as figured in FIG. 5A, FIG. 5B and FIG. 5C), they are spread on the surface of the light guide column 1. Two LED light resources 13 are separately accommodated in the two spaces 12 of the light guide column 1 and electrically connected to a heat conduction element 3. Two LED light resources 13 are powered by the heat conduction element 3 to illuminate, the light path of which is influenced by the microstructures 11 of the light guide column 11 to have light scattering, light refraction and light reflex effects as expected (as figured in FIG. 4). The object is to guide light to the rear area of the light resource module to reduce available area (dark area) and enlarge the illumination area.

The present invention is further provided with a lighting fixture, which comprising above light resource module, a heat emission element 2 and a heat conduction element 3. Several heat emission fins 21 are disposed in the side wall of the heat emission element 2, one end of the heat emission element 2 is disposed with a power socket 22, the other end is disposed with a contact surface 23.

The heat emission fins 21 are spaced disposed on the side wall of the heat emission element 2 to increase the contact area with the air to accelerate thermal convection and heat emission. The power socket 22 is made of metal to connect to external power and conduct electricity. The contact surface 23 is disposed with a hole (not figured out) to connect to power.

The heat conduction element 3 is a circuit board, one side of which is disposed with several LED light resources 13, the other side is disposed with two power cords (not figured out). Two power cords are passed through the hole and electrically connected to the power socket 22. When circuit is formed, the LED light resources 13 are powered to illuminate. The heat conduction element 3 is connected to the contact surface 23 to conduct heat of the LED light resources 13 to the heat emission fins 21 from the contact surface 23 for thermal convection and heat emission. In this embodiment, there are three LED light resource modules, which are spaced disposed in equal angle. The number and the arrangement of the LED light resource modules are not limited.

The present invention is provided with a light resource module with larger illumination area, in which light is influenced by the microstructures when passing through the light, coursing light scattering, light refraction and light reflex, so that light is guided to the rear area of the light resource module to enlarge illumination area and reduce unavailable area, making the light resource module and the lighting fixture with larger illumination area. And the light guide column is expertly designed; several light guide columns can be assembled on the light conduction element to increase the lightness.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

What is claimed is:

1. A light resource module with larger illumination area, wherein comprising:
A curve light guide column, the surface of which is formed with several microstructures with light scattering, light refraction or light reflex functions; and
Two LED light resources, which are corresponding to the two ends of the light guide Column.

2. A light resource module with larger illumination area according to claim 1, wherein two ends of the light guide column are separately disposed with a space, two LED light sources are separately accommodated inside the two spaces.

3. A light resource module with larger illumination area according to claim 1, wherein the microstructures on the surface of the light guide column are pyramid shaped, conical shaped or spherical shaped.

4. A light resource module with large illumination area according to claim 3, wherein the microstructures on the surface of the light guide column are spread on the surface of the light guide column

5. A light resource module with larger illumination area according to claim 1, wherein the two LED light sources are connected to a heat conduction element.

6. A lighting fixture, wherein comprising:
At least a curve light guide column, the surface of the light guide column is disposed with several microstructures with light scattering, light refraction or light reflex functions;
At least two LED light resources, which are corresponding to the two ends of the light guide column;
A heat emission element, which is disposed with several heat emission fins, one end of the heat emission element is disposed with a power socket, the other end is disposed with a contact surface; and
A heat conduction element, which is connected to the contact surface, the light guide column is assembled in the heat conduction element.

7. A lighting fixture according to claim 6, wherein two ends of the light guide column are separately disposed with a space, the LED light sources are separately accommodated in the spaces.

8. A lighting fixture according to claim 6, wherein the light emission fins are spaced arranged.

9. A lighting fixture according to claim 6, wherein the light conduction element is a circuit board.
